(19) United States
(12) Patent Application Publication
(10) Pub. No.: US 2015/0340682 A1
(43) Pub. Date: Nov. 26, 2015

(54) PROCESSING APPARATUS, INJECTION TREATMENT METHOD, AND METHOD OF MANUFACTURING ELECTRODE MATERIAL

(71) Applicant: NIKON CORPORATION, Tokyo (JP)

(72) Inventors: Tatsuya SEKIMOTO, Iwanuma (JP); Junichi IIZAKA, Natori (JP)

(73) Assignee: NIKON CORPORATION, Tokyo (JP)

(21) Appl. No.: 14/813,785

(22) Filed: Jul. 30, 2015

Related U.S. Application Data
(63) Continuation of application No. PCT/JP2014/052280, filed on Jan. 31, 2014.

(30) Foreign Application Priority Data
Jan. 31, 2013 (JP) 2013-017280

(51) Int. Cl. H01M 4/04; B05D 1/02; B05B 1/00

(52) U.S. Cl. CPC H01M 4/0419; H01M 4/0404; B05B 1/005; B05D 1/02

(57) ABSTRACT

A processing apparatus includes: a seal chamber that communicates with interior and exterior of a main chamber; an evacuation unit that evacuates a gas from the main and/or the seal chamber; and a control unit that controls a first differential pressure between a pressure in the seal chamber and a first reference pressure by the evacuation unit; wherein: the evacuation unit has a first evacuation system that evacuates the gas from the seal chamber; the control unit has a first and second mode as operating modes for controlling the first differential pressure, the first evacuation system operating with a feedback control based on the first differential pressure in the first mode and with a control different from the feedback control in the second mode; and the control unit shifts the operating mode from the first to the second mode in accordance with increase in the gas in the main chamber.

### INCORPORATION BY REFERENCE

This application is a continuation of international application No. PCT/JP2014/052280 filed Jan. 31, 2014.

The disclosures of the following priority applications are herein incorporated by reference:

Japanese Patent Application No. 2013-17280 filed Jan. 31, 2013;
International Application No. PCT/JP2014/052280 filed Jan. 31, 2014.

### BACKGROUND OF THE INVENTION

1. Field of the Invention

The present invention relates to a processing apparatus, an injection treatment method, and a method of manufacturing an electrode material.

2. Description of Related Art

Japanese Laid-Open Patent Publication No. 2006-22922 discloses that, in order to achieve gas tightness of a process chamber in which thin film materials are subjected to processes, seal devices having a labyrinth mechanism that complicates a diffusion path of gas entering the process chamber.

### SUMMARY OF THE INVENTION

However, it is difficult to achieve both a high quality of the product and suppression of reduction in gas tightness of the process chamber because baffle plates constructing the labyrinth mechanism of the seal device contact the product, which damages the product or constitutes an obstruction when the materials are fed into the process chamber.

According to the 1st aspect of the present invention, a processing apparatus comprises: a main chamber; a treatment unit that injects a gas in the main chamber; a seal chamber that communicates with both interior and exterior of the main chamber; an evacuation unit that evacuates the gas from the interior of the main chamber and/or the seal chamber; and a control unit that controls a first differential pressure between a pressure in the seal chamber and a first reference pressure by causing the evacuation unit to operate; wherein: the evacuation unit has a first evacuation system that evacuates the gas from the interior of the seal chamber; the control unit has a first mode and a second mode as operating modes of the evacuation unit for controlling the first differential pressure, in the first mode the control unit causing the first evacuation system to operate with a feedback control based on the first differential pressure and in the second mode the control unit causing the first evacuation system to operate with a control different from the feedback control based on the first differential pressure; and the control unit shifts the operating mode from the first mode to the second mode in accordance with increase in an amount of the gas injected by the treatment unit in the main chamber.

According to the 2nd aspect of the present invention, it is preferred that in the processing apparatus according to the 1st aspect the control unit shifts the operating mode from the first mode to the second mode if the amount of the gas injected by the treatment unit in the main chamber exceeds a first threshold.

According to the 3rd aspect of the present invention, it is preferred that in the processing apparatus according to the 1st aspect in the second mode, the control unit causes the first evacuation system to evacuate the gas with a preset predetermined evacuation quantity.

According to the 4th aspect of the present invention, it is preferred that in the processing apparatus according to the 1st aspect the control unit shifts the operating mode from the second mode to the first mode in accordance with decrease in the pressure in the seal chamber in the second mode.

According to the 5th aspect of the present invention, it is preferred that in the processing apparatus according to the 1st aspect the control unit shifts the operating mode from the second mode to the first mode when a predetermined time has elapsed since the operation mode had been shifted to the second mode.

According to the 6th aspect of the present invention, it is preferred that in the processing apparatus according to the 4th aspect the control unit shifts the operating mode from the second mode to the first mode if the first differential pressure is lower than the second threshold while the second mode continues.

According to the 7th aspect of the present invention, it is preferred that in the processing apparatus according to the 1st aspect the first evacuation system comprises a first evacuation device that evacuates the gas from the interior of the seal chamber, and a first variable valve provided on an intake side or an evacuation side of the first evacuation device; and the control unit controls the first differential pressure by changing at least one of an evacuating capability of the first evacuation device and a valve aperture of the first variable valve.

According to the 8th aspect of the present invention, it is preferred that in the processing apparatus according to the 1st aspect the evacuation unit has a second evacuation system that evacuates the gas from the interior of the main chamber; the control unit further has a third mode and a fourth mode as operating modes of the evacuation unit for controlling a second differential pressure between the pressure in the main chamber and the second reference pressure, in the third mode the control unit causing the second evacuation system to operate with a feedback control based on the second differential pressure and in the fourth mode the control unit causing the second evacuation system to operate with a control different from the feedback control based on the second differential pressure; and the control unit shifts the operating mode from the third mode to the fourth mode, in accordance with the amount of the gas injected by the treatment unit in the main chamber.

According to the 9th aspect of the present invention, it is preferred that in the processing apparatus according to the 8th aspect the control unit shifts the operating mode from the third mode to the fourth mode if the amount of the gas injected by the treatment unit in the main chamber exceeds a third threshold.

According to the 10th aspect of the present invention, it is preferred that in the processing apparatus according to the 8th aspect, in the fourth mode, the control unit causes the second evacuation system to evacuate the gas from the interior of the main chamber with a preset predetermined evacuation quantity.

According to the 11th aspect of the present invention, it is preferred that in the processing apparatus according to the 8th aspect the control unit shifts the operating mode from the fourth mode to the third mode in accordance with decrease in pressure in the main chamber in the fourth mode.

According to the 12th aspect of the present invention, it is preferred that in the processing apparatus according to the 8th aspect the control unit shifts the operating mode from the fourth mode to the third mode, when a predetermined time has elapsed since the operating mode had been shifted to the fourth mode.

According to the 13th aspect of the present invention, it is preferred that in the processing apparatus according to the 11th aspect the control unit shifts the operating mode of the second evacuation system from the fourth mode to the third mode if the second differential pressure is lower than the fourth threshold while the fourth mode continues.

According to the 14th aspect of the present invention, it is preferred that in the processing apparatus according to the 8th aspect the second evacuation system comprises a second evacuation device that evacuates the gas from the interior of the seal chamber, and a second variable valve provided on an intake side or an evacuation side of the second evacuation device; and the control unit controls the second differential pressure by changing at least one of an evacuating capability of the second evacuation device and a valve aperture of the second variable valve.

According to the 15th aspect of the present invention, it is preferred that in the processing apparatus according to the 8th aspect the second evacuation system has a return path that returns the gas from the evacuation side of the second evacuation device into the main chamber, and a third variable valve provided in the return path; and the control unit controls the second differential pressure by changing at least one of an evacuating capability of the second evacuation device and valve apertures of the second variable valve and the third variable valve.

According to the 16th aspect of the present invention, it is preferred that in the processing apparatus according to the 15th aspect the control unit changes the valve apertures of the second variable valve and the third variable valve in a complementary manner.

According to the 17th aspect of the present invention, it is preferred that in the processing apparatus according to the 1st aspect the first reference pressure is a pressure of the interior of the main chamber or a pressure of the exterior of the seal chamber.

According to the 18th aspect of the present invention, it is preferred that in the processing apparatus according to the 8th aspect the second reference pressure is a pressure of the exterior of the main chamber or a pressure of the interior of the seal chamber.

According to the 19th aspect of the present invention, it is preferred that in the processing apparatus according to the 8th aspect the first threshold is lower than the third threshold.

According to the 20th aspect of the present invention, an injection treatment method comprises: performing an injection treatment on a workpiece, by using the processing apparatus according to the 1st aspect, in the main chamber.

According to the 21st aspect of the present invention, it is preferred that in the injection treatment method according to the 20th aspect the injection treatment includes injecting a gas-solid two phase flow to the workpiece.

According to the 22nd aspect of the present invention, an electrical material manufacturing method comprises: forming an active material film on a surface of a collector, by using the processing apparatus according to the 1st aspect.

According to the present invention, the operating mode of the evacuation unit shifts from the first mode for operation with the feedback control to the second mode for operation with a control different from the feedback control in accordance with increase in the amount of the gas injected by the treatment unit into the main chamber, which prevents quality deterioration of the product, while suppressing reduction in gas tightness of the main chamber.

### BRIEF DESCRIPTION OF THE DRAWINGS

FIG. 1 is a block diagram illustrating a configuration of the processing apparatus according to a first embodiment of the present invention.

FIG. 2 is a flowchart illustrating an operation of the processing apparatus according to the first embodiment.

FIG. 3 is a flowchart illustrating an operation of the processing apparatus according to a second embodiment.

FIG. 4 is a block diagram illustrating a configuration of the processing apparatus according to a third embodiment.

FIG. 5 is a flowchart illustrating an operation of the processing apparatus according to the third embodiment.

FIG. 6 is a flowchart illustrating an operation of the processing apparatus according to the third embodiment.

FIG. 7 is a flowchart illustrating an operation of the processing apparatus according to the third embodiment.

FIG. 8 is a flowchart illustrating an operation of the processing apparatus according to the fourth embodiment.

FIG. 9 is a flowchart illustrating an operation of the processing apparatus according to the fourth embodiment.

FIG. 10 is a block diagram illustrating a configuration of the processing apparatus according to a variation.

FIG. 11 is a flowchart illustrating an injection treatment method using the injection treatment device according to the present invention.

### DESCRIPTION OF PREFERRED EMBODIMENTS

A processing apparatus in an aspect of the present invention controls a differential pressure between a pressure in a seal chamber provided in an opening through which workpieces are fed into/out of a main chamber and a pressure of an exterior of the main chamber so as to keep the pressure in the seal chamber lower than the pressure of the exterior of the main chamber, when a processing treatment that involves injection of a gas is performed in an atmosphere of the gas in the main chamber. Thereby, outflow of the gas from the main chamber to the exterior and inflow of outside air from the exterior of the main chamber into the main chamber are suppressed. This will now be described in detail with reference to embodiments.

### First Embodiment

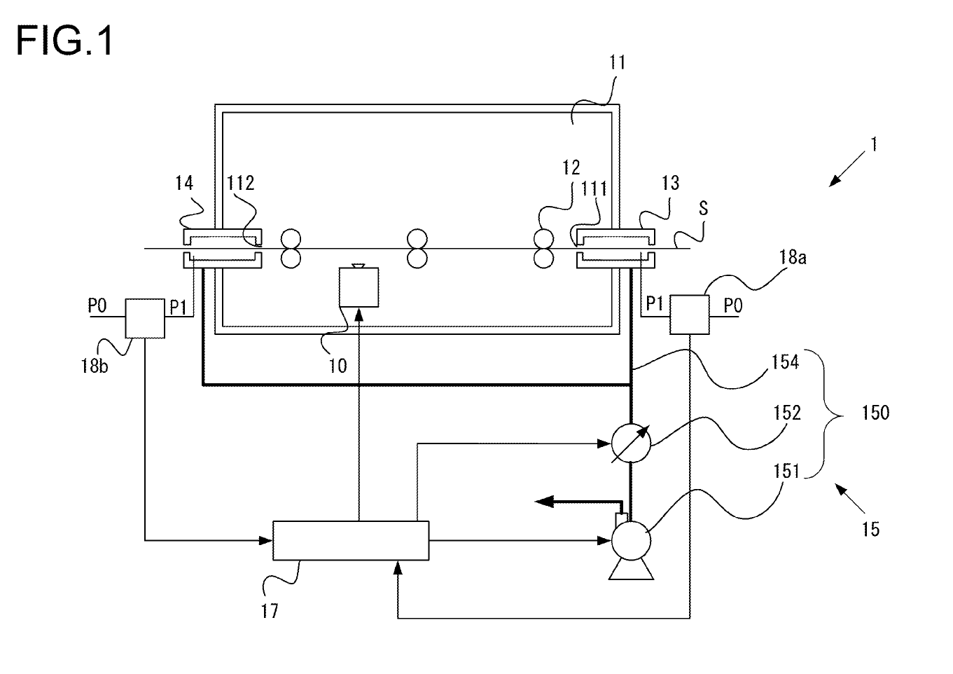

Referring to figures, a processing apparatus 1 according to a first embodiment of the present invention will be described. FIG. 1 is a block diagram schematically illustrating a configuration of the processing apparatus 1. The processing apparatus 1 includes an injection treatment device 10, a main chamber 11, a feeding device 12, an inlet seal chamber 13, an outlet seal chamber 14, an evacuation device 15, a controller 17, and pressure sensors 18a and 18b.

The injection treatment device 10 is provided in the main chamber 11 to perform a film forming treatment on a workpiece S, such as a copper foil which serves as an negative electrode collector of a battery electrode and an aluminum foil which serves as a positive electrode collector of the battery electrode. An example of the injection treatment device 10 is a PJD (Powder Jet Deposition) type film forming treatment device, which mixes particulates supplied from a powder supply device (not shown) with an inert gas such as nitrogen gas supplied from a gas supply source (not shown) and sprays the mixture of the particulates and the inert gas onto the workpiece S.

The following particulates may be used as the particulates injected by the injection treatment device 10, without any particular limitation: particulates of various types of metals such as gold, silver, copper, aluminum, tin, nickel, and titanium; particulates of various types of alloys and intermetallic compounds such as Si—Cu or Si—Sn; particulates of ceramics, such as aluminum oxide and zirconium oxide, and various types of inorganic glass materials; particulates of high molecular compounds, such as polyethylene; and the like. Particulates of different types of materials combined by a mechanical alloying method or the like, or particulates having their surface coated with a different type of material may also be used.

Instead of the PJD type film forming treatment device, various types of film forming treatment devices may be used as the injection treatment device 10, such as a cold spray type and an aerosol deposition type. The injection treatment device 10 is not limited to a device that injects particulates onto the workpiece S to form a film of an electrode active material, but the injection treatment device 10 may be a device that forms a variety of films with particulates injected onto a surface of the workpiece S to be treated. The injection treatment device 10 may also be a removal treatment device that performs a removal treatment with particulates injected onto the surface of the workpiece S to be treated. The workpiece S may be selected depending on the purpose of treatment, as appropriate.

When performing the treatment, the injection treatment device 10 injects the inert gas mixed with the particulates with an injection quantity T1 (m³/min), in response to an injection command from the controller 17. The controller 17 stores a plurality of injection quantities T1 and increases/decreases the injection quantity T1 (including stop of the injection) at the appropriate timing in accordance with a preset processing program. Furthermore, the injection treatment device 10 can increase/decrease the injection quantity T1 in a predetermined time interval.

The main chamber 11 is an enclosure in which the injection treatment device 10 performs the treatment on the workpiece S in a constant gas atmosphere, for the purposes of preventing oxidation, explosion, moisture, or the like of the workpiece S and the injected particulates. An inlet port 111 for feeding the workpiece S into the main chamber 11 and an outlet port 112 for feeding the workpiece S having been treated by the injection treatment device 10 in the main chamber 11 to the exterior are provided in the main chamber 11. The main chamber 11 is a sealed enclosure that has substantially no opening through which it communicates with the exterior, except for the inlet port 111 and the outlet port 112.

The feeding device 12 is composed of a plurality of rollers and the like, and the feeding device 12 feeds the workpiece S shaped in a sheet form into the main chamber 11 through the inlet port 111 and feeds the workpiece S having been treated in the main chamber 11 out of the main chamber 11 through the outlet port 112. Therefore, the injection treatment device 10 can perform the treatment on the workpiece S in a so-called “Roll to Roll” scheme. In this embodiment, a feeding speed of the workpiece S fed by the feeding device 12 may be 1 mm/sec to 100 mm/sec, as one example. The workpiece S may be continuously fed or intermittently fed in which pause and resume of the feed are alternately repeated as required. The inlet port 111 and the outlet port 112 are suitably sized so as to feed the workpiece S with a suitable clearance (spacing) between the port 111, 112 and the workpiece S. From the viewpoint of keeping gas tightness of the main chamber 11, it is preferable to set the spacing between the port 111, 112 and the workpiece S as small as possible. In this embodiment, the inlet port 111 and the outlet port 112 are not required to have a special mechanism such as a labyrinth structure.

The inlet seal chamber 13 is provided on an outer side of the inlet port 111 of the main chamber 11 and communicates with both the interior and the exterior of the main chamber 11. The outlet seal chamber 14 is provided on an outer side of the outlet port 112 of the main chamber 11 and communicates with both the interior and the exterior of the main chamber 11. The inlet seal chamber 13 and the outlet seal chamber 14 are provided to prevent outflow of the inert gas in the main chamber 11 to the exterior and inflow of outside air into the main chamber 11. For this purpose, pressures P1a in the inlet seal chamber 13 and pressure P1b in the outlet seal chamber 14 are controlled by the evacuation device 15 described later so that a differential pressure between the pressure P1a, P1b and an external pressure P0 is within a predetermined range. It is to be noted that the phrase “within a predetermined range” as used herein refers to a range of the differential pressure within which outflow of the inert gas and particulates in the main chamber 11 to the exterior through the inlet seal chamber 13 or the outlet seal chamber 14 can be prevented, as described later.

If the inlet seal chamber 13 and the outlet seal chamber 14 are symmetrical with respect to the main chamber 11 in their structure, the pressures P1a and P1b are substantially the same at any time. The external pressure P0 has the same value for both seal chambers, as well. In this case, it is therefore only necessary to control the differential pressure between either one of the pressures P1a and P1b and the exterior pressure P0 to be within the predetermined range. On the other hand, if the inlet seal chamber 13 and the outlet seal chamber 14 are asymmetrical with respect to the main chamber 11 in their structure, there may be a difference between pressures P1a and P1b. In this case, it is only necessary to select one of the pressures P1a and P1b that has a smaller differential pressure between it and the external pressure P0, as the pressure to be controlled. This is because the possibility of outflow of the gas and particulates from the seal chamber to the exterior is increased as the differential pressure between the seal chamber pressure and the external pressure P0 is smaller. It is to be noted that the term “seal chamber pressure” or “P1”, as simply used in the following description without any distinction between the inlet seal chamber 13 and the outlet seal chamber 14, refers to a seal chamber pressure to be controlled, which is selected as described above. Furthermore, if the pressure in the seal chamber is higher than the external pressure, the differential pressure is negative.

In this embodiment, it is preferable to keep the seal chamber pressure P1 lower than the external pressure P0 by approximately 8 Pa to 13 Pa, in order to prevent outflow of the inert gas and particulates in the main chamber 11 to the exterior through the inlet seal chamber 13 or the outlet seal chamber 14. In this embodiment, the gas supplied from the exterior is injected by the injection treatment device 10 into the main chamber 11. Then, the gas is evacuated from the seal chamber 13 and the outlet seal chamber 14 so that the seal chamber pressures P1a and P1b are lower than the pressure in the main chamber 11 at any time.

The evacuation device 15 has a first evacuation system 150 including a first fan 151, a first variable valve 152, and a duct 154 and the evacuation device 15 operates in accordance with the command from the controller 17 described later to evacuate the gas from the inlet seal chamber 13 and the outlet seal chamber 14. The first fan 151 is constituted of a turbofan and the like, and the first fan 151 activates in response to input of a drive signal from the controller 17 described later to evacuate the gas in the inlet seal chamber 13 and the outlet seal chamber 14 to the exterior of the main chamber 11. A fan that varies a number of rotations of a rotating blade, a fan that varies an angle of the rotating blade, or a combination of both may be used as the first fan 151. The amount that can be evacuated out of the inlet seal chamber 13 and the outlet seal chamber 14 (an evacuating capability) is set on the basis of the number of rotations of the rotating blade, the angle of the rotating blade, or a combination of both in accordance with the drive signal from the controller 17.

The first variable valve 152 is constituted of a motor-driven electrical control valve. In the first variable valve 152, a valve aperture of the electrical control valve is adjusted in accordance with a valve aperture signal input from the controller 17 as described later in order to set the evacuation quantity of the gas evacuated from the inlet seal chamber 13 and the outlet seal chamber 14 to the exterior.

The first fan 151 and the first variable valve 152 described above are provided in the duct 154. As illustrated in FIG. 1, the first variable valve 152 is provided on an intake side of the first fan 151. With the adjustment of the first fan 151 and the first variable valve 152 as described above, the inert gas in the inlet seal chamber 13 and the outlet seal chamber 14 is evacuated to the exterior through the duct 154. The first variable valve 152 may be provided in the duct 154 on an evacuation side of the first fan 151, instead of being provided in the duct 154 on the intake side of the first fan 151 as illustrated in FIG. 1.

The pressure sensors 18a and 18b are differential pressure gauges, each of which has two pressure measurement ports and detects and outputs a differential pressure between two input pressures. One of the pressure measurement ports in the pressure sensor 18a or 18b is open to the exterior of the main chamber 11, while the other is connected to each seal chamber. Therefore, the pressure sensors 18a and 18b detect the differential pressures between the external pressure P0 and the pressure P1a in the inlet seal chamber 13 and between the external pressure P0 and the pressure P1b in the outlet seal chamber 14, respectively, and then output signals according to the detected differential pressures (referred to as “differential pressure signals” hereinafter) to the controller 17.

The controller 17 is an arithmetic operation unit that has CPUs, ROMs, RAMs, etc., and executes a variety of data processes. The controller 17 causes the evacuation device 15 to operate on the basis of the input differential pressure signal so as to regulate the evacuation quantity of the gas from the inlet seal chamber 13 and the outlet seal chamber 14 and consequently control the differential pressure between the pressure in the seal chamber and the external pressure. In this case, the controller 17 outputs to the first fan 151 a drive signal that instructs the first fan 151 to drive. The controller 17 also outputs to the first variable valve 152 a valve aperture signal that specifies the valve aperture of the electrical control valve constituting the first variable valve 152. The controller 17 selects a first mode or a second mode for an operating mode of the first evacuation system 150 in order to regulate the evacuation quantity of the gas from the inlet seal chamber 13 and the outlet seal chamber 14.

(1) First Mode

In the first mode, the controller 17 performs a feedback control in order to cause the first evacuation system 150 to operate on the basis of the differential pressure between the pressure in the seal chamber and the external pressure. In this case, the controller 17 calculates the valve aperture of the first variable valve 152, i.e. the operation amount of the electrical control valve with the first transfer function in which the differential pressure ΔP1 between the seal chamber pressure P1 and the external pressure P0, which is the first reference pressure, is a controlled variable. The controller 17 then outputs the valve aperture to the first variable valve 152 as the valve aperture signal. The first transfer function is a function of calculating the operation amount of the first valve 152 for the purpose of performing a feedback control on the differential pressure ΔP1, such as a PI control and a PID control. There is no particular limitation on the functional form of the first transfer function in this embodiment and a transfer function such as a P control, a PI control, or a PID control may be implemented and used as appropriate, depending on response characteristics of a controlled system or the like. Thus, the evacuation quantity of the gas from the inlet seal chamber 13 and the outlet seal chamber 14 is regulated.

(2) Second Mode

In second mode, the controller 17 causes the first evacuation system 150 to operate to evacuate the gas from the inlet seal chamber 13 and the outlet seal chamber 14, by performing a feedforward control, instead of the feedback control. In this case, the controller 17 outputs an injection command to the injection treatment device 10, while setting the operation amount of the electrical control valve in the first variable valve 152 to a predetermined value and outputting the operation amount to the first variable valve 152 as the valve aperture signal. For example, the controller 17 outputs the valve aperture signal so that the valve aperture of the electrical control valve in the first variable valve 152 is kept at the maximum valve aperture. Accordingly, the first evacuation system 150 operates with the evacuation quantity according to the valve aperture of the first variable valve 152. It should be noted that the valve aperture of the electrically-controlled valve in the first variable valve 152 is kept not exclusively at the maximum valve aperture, but may be kept at a preset valve aperture, such as 90% or 80% of the maximum valve aperture, or may vary over time, which is also included within the scope of the present invention. Furthermore, the operation amount of the electrical control valve described above has previously been measured by experiments or the like and recorded in a predetermined memory (not shown) herein as a value providing an evacuation quantity with which the inert gas suddenly increasing in the main chamber 11 in the course of the treatment by the injection treatment device 10 can be evacuated with the outflow of the gas to the exterior being suppressed even if the evacuation quantity of the gas is regulated in the first mode after a time t1 described later has elapsed. It should be noted that the first evacuation system 150 is activated not exclusively simultaneously with output of the injection command to the injection treatment device 10, but may be activated at a time prior to the output of the injection command by a predetermined time or may be activated on the basis of the injection quantity from the injection treatment device 10, which is also included within the scope of the present invention.

The controller 17 switches the above-described first mode and second mode as appropriate so as to regulate the evacuation quantity of the gas from the inlet seal chamber 13 and the outlet seal chamber 14 and consequently control the differential pressure ΔP1 between the seal chamber pressure P1 and the external pressure P0. As described above, each of the inlet seal chamber 13 and the outlet seal chamber 14 communicates with the main chamber 11 and has a pressure therein lower than the pressure in the main chamber 11. Therefore, by evacuating the gas from the inlet seal chamber 13 and the outlet seal chamber 14, the inert gas injected by the injection treatment device 10 into the main chamber 11 flows into the inlet seal chamber 13 and the outlet seal chamber 14 and then is evacuated to the exterior by the evacuation device 15. A detoxifying device, such as a scrubber and a filter and so on, may be installed at the evacuation end of the evacuation device 15, as required. Settings of the first mode and the second mode with the controller 17 will now be described.

The controller 17 sets the operating mode of the evacuation device 15 to the first mode or the second mode, in accordance with the injection quantity T1 of the inert gas injected by the injection treatment device 10 during the treatment. In other words, the controller 17 performs shift and return between the first mode and the second mode, as required. In this embodiment, the controller 17 sets the operating mode as the first mode if the injection quantity T1 of the inert gas to be injected by the injection treatment device 10 is not more than a preset predetermined threshold T1a, while the controller 17 sets the operating mode as the second mode if the injection quantity T1 exceeds the threshold T1a. During the operation of the evacuation device 15 in the first mode, if it is determined that the injection quantity T1 exceeds the threshold T1a, the controller 17 shifts the operating mode from the first mode to the second mode. The above-described threshold T1a has previously been measured by experiments or the like and recorded in a predetermined memory (not shown) herein as an evacuation quantity with which outflow of the gas to the exterior can be suppressed, even if the inert gas suddenly increasing in the main chamber 11 in the course of the treatment by the injection treatment device 10 is regulated in the first mode. If the injection treatment device 10 is controlled independently of the controller 17, a signal indicating the injection quantity T1 injected by the injection treatment device 10 may be transmitted to the controller 17 at the same time as the injection or prior to the injection.

Once the operation of the evacuation device 15 shifts to the second mode, the controller 17 initiates a timer (not shown) to start a measurement of the time from the start of the operation of the evacuation device 15 in the second mode. When the predetermined time t1 has elapsed since the start of the time measurement, the controller 17 shifts the operating mode of the evacuation device 15 from the second mode to the first mode. In other words, the controller 17 performs a feedback control of calculating the valve aperture of the electrical control valve in the first variable valve 152 by setting the differential pressure ΔP1 between the seal chamber pressure P1 and the external pressure P0 as the controlled variable, and outputting the valve aperture to the first variable valve 152 as the valve aperture signal. The above-described predetermined time t1 has previously been measured by experiments or the like and recorded in a predetermined memory (not shown) herein as a time required until the inert gas suddenly increasing in the main chamber 11 in the course of the treatment by the injection treatment device 10 is evacuated by the operation of the first evacuation system 150 in the second mode so that the differential pressure ΔP1 can be controlled by the operation of the first evacuation system 150 in the first mode.

It should be noted that although the controller 17 changes the valve aperture of the electrical control valve in the first variable valve 152 in this embodiment, the controller 17 may change the evacuating capability of the first fan 151 or may change a combination of the evacuating capability of the first fan 151 and the valve aperture of the electrical control valve in the first variable valve 152, which is also included within the scope of the present invention.

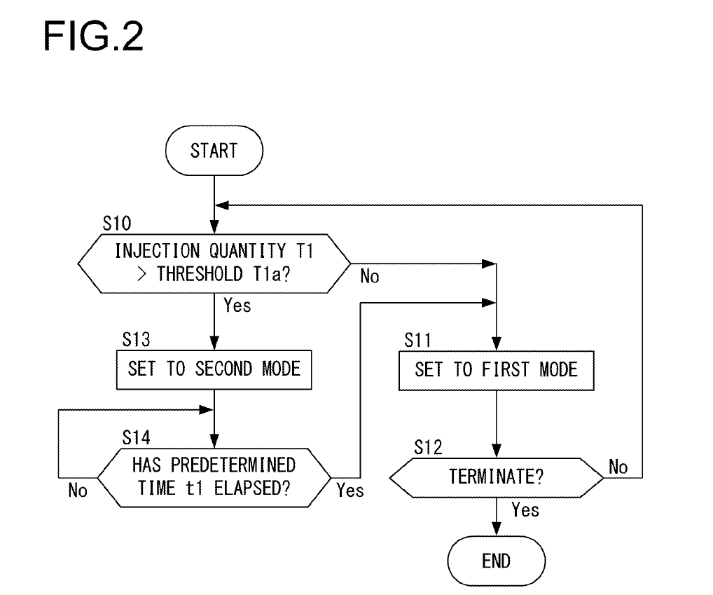

The processes of the controller 17 will be described with reference to a flowchart in FIG. 2. Each process illustrated in the flowchart in FIG. 2 is performed by executing a program on the controller 17. The program has been stored in a memory (not shown) and is initiated and executed by the controller 17 with the start of the operation of the processing apparatus 1.

In step S10, it is determined if the injection quantity T1 of the inert gas injected by the injection treatment device 10 exceeds the threshold T1a. If the injection quantity T1 is not more than the threshold T1a, the determination in step S10 is negative and the process flow proceeds to step S11. In step S11, the evacuation device 15 is operated in the first mode and the process flow proceeds to step S12. In step S12, it is determined if the operation of the processing apparatus 1 should be terminated. If the operation of the processing apparatus 1 should be terminated, the determination in step S12 is positive and the process ends. If the processing apparatus 1 continues its operation, the determination is step S12 is negative and the process returns to step S10.

If the injection quantity T1 of the inert gas injected by the injection treatment device 10 in step S10 exceeds the threshold T1a, the determination in step S10 is positive and the process flow proceeds to step S13. In step S13, the evacuation device 15 is operated in the second mode and the process flow proceeds to step S14. In step S13, a timer (not shown) is initiated to start a time measurement. In step S14, it is determined if a predetermined time t1 has elapsed since the start of the time measurement with the timer in step S13. If the predetermined time t1 has elapsed, the determination in step S14 is positive and the process flow proceeds to step S11. If the predetermined time t1 has not elapsed, the determination in step S14 is negative and the process in step S14 is repeated.

A above-described treatment method performed by the injection treatment device 10 in the processing apparatus 1 will be described. Once the processing apparatus 1 initiates its operation, the feeding device 12 starts to feed the workpiece S shaped in a sheet form into the main chamber 11 through the inlet port 111 in the Roll to Roll scheme. The controller 17 starts to control the differential pressure ΔP1 between the seal chamber pressure P1 and the external pressure P0. The injection treatment device 10 injects a fluid mixture of the particulates and the gas toward the workpiece S fed in the main chamber 11. In this case, from the viewpoint of preventing outflow of the inert gas from the main chamber 11 to the exterior, it is preferable to start the operation of the evacuation device 15 before the start of the injection of the fluid mixture by the injection treatment device 10. The injected particulates impinge on and attach to a surface to be treated of the workpiece S that has been fed to a position at a distance of approximately 0.5 mm to 5 mm from an injection port (not shown) of the injection treatment device 10. The treated workpiece S having the particulates attached thereto is sequentially fed out to the exterior of the main chamber 11 through the outlet port 112 by the feeding device 12.

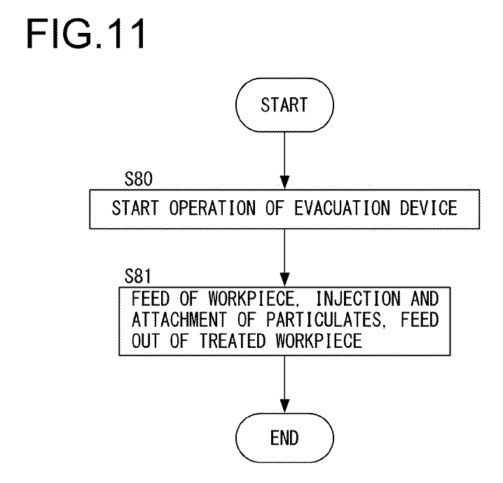

A treatment method using the injection treatment device 10 will be described with reference to a flowchart illustrated in FIG. 11. In step S80, the controller 7 causes the evacuation device 15 to operate to start the control of the differential pressure ΔP1 between the seal chamber pressure P1 and the external pressure P0, and the process flow proceeds to step S81. In step S81, the feeding device 12 starts to feed the workpiece S into the main chamber 11, and the injection treatment device 10 injects the fluid mixture of the particulates and the gas toward the workpiece S so that the fluid mixture impinges on and attaches to the surface to be treated. Then, the treated workpiece S is fed out to the exterior of the main chamber 11 by the feeding device 12 and the process ends.

With the processing apparatus 1 described above, an active material film is formed on the electrode substrate by the PJD (Powder Jet Deposition) method in order to create an negative electrode material for a battery such as a lithium ion secondary battery. In this case, the electrode substrate as the workpiece S is an electrically conductive substrate made of Cu (copper), electrically conductive resins, or the like, which is a material for constituting a collector. Also in the case of manufacturing an electrode material, the active material film can be formed on the surface of the material composing the collector in the same manner as in the treatment method using the injection treatment device 10 illustrated in FIG. 11.

This electrode material is punched out into a shape and dimensions matched to a battery form (for example, cylinder-type, square-type, cell-type, or laminate-type) to create the negative electrode. A known positive electrode that is formed by attaching a lithium transition metal oxide such as lithium cobalt oxide as a positive electrode active material to an aluminum foil, and the above-described negative electrode are oppositely arranged to each other with a separator therebetween, and they are encapsulated with a known electrolyte (nonaqueous electrolyte) in a known solvent in order to create a lithium ion secondary battery. The known solvent is propylene carbonate, ethylene carbonate, or the like and a known electrolyte is LiClO₄, LiPF₆, or the like. In this way, a lithium ion secondary battery having a high electrical capacity and a long term stability is achieved. Instead of forming the negative electrode material of the lithium ion secondary battery, a positive electrode material may be formed with the injection treatment device 1. In this case, an electrically conductive substrate made of aluminum, electrically conductive resins, or the like is used as the electrode substrate.

According to the processing apparatus 1 in the first embodiment described above, the following advantages can be achieved.

(1) The controller 17 shifts the operating mode of the evacuation device 15 between the first mode and the second mode to regulate the evacuation quantity from the first evacuation system 150 and thus controls the differential pressure ΔP1 between the seal chamber pressure P1 and the external pressure P0. In the first mode, the controller 17 performs the feedback control on the differential pressure ΔP1 in accordance with the operation amount calculated with the first transfer function in which the differential pressure ΔP1 between the seal chamber pressure P1 and the external pressure P0 that is a first reference pressure is a controlled variable. In the second mode, the controller 17 sets the evacuation quantity to a predetermined set value, irrespective of the differential pressure ΔP1 between the seal chamber pressure P1 and the external pressure P0. Furthermore, the controller 17 is adapted to shift the control mode (operating mode) of the first evacuation system 150 from the first mode to the second mode if the injection quantity T1 of the inert gas injected by the injection treatment device 10 into the main chamber 11 exceeds the threshold T1a.

With the above-described configuration, the processing apparatus 1 according to the first embodiment controls the differential pressure ΔP1 between the seal chamber pressure P1 and the external pressure P0 with the first evacuation system 150 so that the seal chamber pressure P1 is lower than the external pressure P0, by switching between the feedforward control and the feedback control. Therefore, if the differential pressure ΔP1 between the seal chamber pressure P1 and the external pressure P0 is within the predetermined range, the seal chamber pressure P1 can be kept lower than the external pressure P0 by a predetermined pressure with the feedback control. If it is expected that the inert gas injected by the injection treatment device 10 suddenly increases and the differential pressure ΔP1 is out of the range of the feedback control, the gas is evacuated from the seal chamber with the feedforward control, with the result that the differential pressure ΔP1 can be quickly returned to a value that can be controlled with the feedback control so that the seal chamber pressure P1 can be lower than the external pressure P0 by a predetermined amount. Consequently, outflow of the inert gas from the main chamber 11 and inflow of outside air into the main chamber 11 can be suppressed, even if the treatment that involves injecting a large amount of the inert gas in a short time is performed by the injection treatment device 10. In other words, gas tightness of the main chamber 11 can be kept without a special labyrinth mechanism or the like for preventing outflow of the inert gas from the main chamber 11 to the exterior of the main chamber 11 and inflow of oxidizing gas from the exterior of the main chamber 11 into the main chamber 11. Moreover, defects such as scratch onto the workpiece S are avoided and quality deterioration of the product can be prevented because it is not necessary to provide a seal member that contacts the workpiece S. Furthermore, the feeding device 12 can drive without any disturbance to feed the workpiece S into/out of the main chamber 11, because it is not necessary to provide a seal member that contacts or can contact the workpiece S.

(2) The controller 17 is adapted to shift the operating mode of the evacuation device 15 from the second mode to the first mode, when the predetermined time t1 has elapsed since the shift to the second mode. Therefore, by switching between the feedback control and the feedforward control with a simple mechanism as appropriate, the seal chamber pressure P1 can be kept lower than the external pressure P0 to suppress outflow of the inert gas from the main chamber 11 to the exterior and inflow of outside air into the main chamber 11.

(3) The first evacuation system 150 includes the first fan 151 for evacuating the inert gas in the inlet seal chamber 13 and the outlet seal chamber 14 to the exterior, and the first variable valve 152 that is provided on the intake side or the evacuation side of the first fan 151. Furthermore, the controller 17 is adapted to control at least one of the evacuating capability of the first fan 151 and the valve aperture of the first variable valve 152 to regulate the evacuation quantity of the first evacuation system 150. Therefore, the seal chamber pressure P1 can be kept lower than the external pressure P0 by a simple structure with a fan to keep gas tightness of the main chamber 11. It is possible to achieve the same effect with a vacuum pump such as a rotary pump, a rolling piston type pump, or the like, instead of the first fan 51.

(4) The differential pressure ΔP1 between the seal chamber pressure P1 and the external pressure P0 is controlled to be within the predetermined range. As a result, outflow of the inert gas from the main chamber 11 and inflow of outside air into the main chamber 11 can be suppressed, even in the event of an emergency shutdown of the processing apparatus 1 due to power failure, for example.

### Second Embodiment

A processing apparatus according to a second embodiment of the present invention will be described. In the following description, the same component as those of the first embodiment are denoted by the same reference numerals and differences between the first embodiment and the second embodiment will be mainly described. The matters that are not particularly described are the same as in the first embodiment. This embodiment differs from the first embodiment in that the operating mode of the evacuation device is shifted from the second mode to the first mode in accordance with the seal chamber pressure decreased by the evacuation device operating in the second mode.

The processing apparatus 1 according to the second embodiment has the same configuration as in the first embodiment illustrated in FIG. 1. The controller 17 calculates the valve aperture of the first variable valve 152, i.e. the operation amount of the electrical control valve with a first transfer function in which the differential pressure ΔP1 between the seal chamber pressure P1 and the external pressure P0 input from the pressure sensor 18a or 18b is a controlled variable, even after starting the operation of the evacuation device 15 in the second mode. The controller 17 performs comparison between the calculated operation amount and a predetermined threshold T2a. If the comparison shows that the calculated operation amount is not more than the threshold T2a, the controller 17 determines that the differential pressure ΔP1 between the seal chamber pressure P1 and the external pressure P0 decreases to a pressure that can be controlled in the first mode. The controller 17 then shifts the operation of the evacuation device 15 from the second mode to the first mode.

The controller 17 performs the calculation of the operation amount and the comparison between the operation amount and the threshold T2a described above in a predetermined period (time interval), while the evacuation device 15 continues to be operated in the second mode. The above-described threshold T2a has previously been measured by experiments or the like and recorded in a predetermined memory (not shown) herein as the maximum operation amount that can be evacuated in the first mode without hunting or the like generated by the inert gas suddenly increasing in the main chamber 11 in the course of the treatment by the injection treatment device 10.

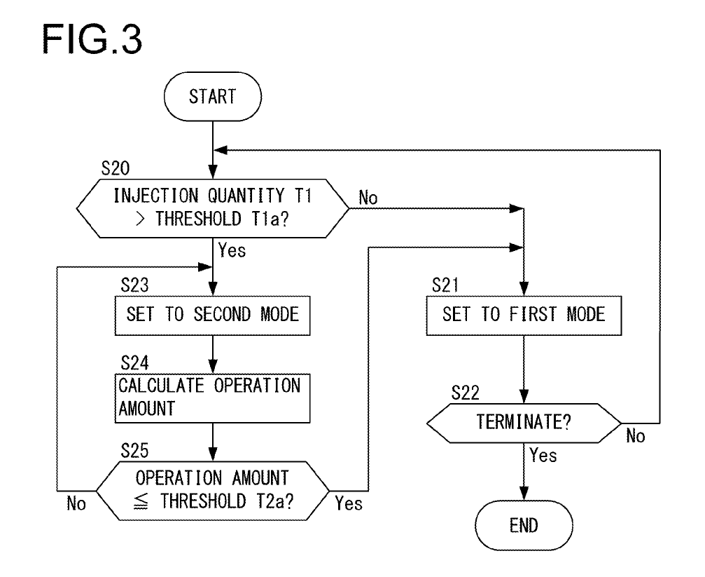

The processes of the controller 17 will be described with reference to a flowchart in FIG. 3. Each process illustrated in the flowchart in FIG. 3 is performed by executing a program on the controller 17. The program has been stored in a memory (not shown) and is initiated and executed by the controller 17 with the start of the operation of the processing apparatus 1.

Each of processes in step S20 (determination of magnitude relation between the injection quantity T1 and the threshold T1a) to step S23 (set to the second mode) is the same as each of processes in step S10 (determination of magnitude relation between the injection quantity T1 and the threshold T1a) to step S13 (set to the second mode) in FIG. 2. In step S24, the valve aperture of the first variable valve 152, i.e. the operation amount of the electrical control valve is calculated with a first transfer function in which the differential pressure ΔP1 between the seal chamber pressure P1 and the external pressure P0 input from the pressure sensor 18a or 18b is a controlled variable, and the process flow proceeds to step S25.

In step S25, it is determined if the calculated operation amount is not more than the threshold T2a. If the operation amount is not more than the threshold T2a, the determination in step S25 is positive and the process flow proceeds to step S21. If the operation amount exceeds the threshold T2a, the determination in step S25 is negative and the process returns to step S23.

According to the processing apparatus 1 in the second embodiment described above, the following advantages can be achieved, in addition to the advantages (1), (3), and (4) achieved by the first embodiment.

The controller 17 is adapted to calculate the value of the operation amount with the first transfer function during the continuation of the second mode and return the control mode (operating mode) of the first evacuation system 150 from the second mode to the first mode if the value of the calculated operation amount is lower than the threshold T2a. Therefore, because the return to the first mode can be directly performed on the basis of the operation amount, the differential pressure ΔP1 can be kept at a desired pressure with a higher accuracy than that in the return to the first mode on the basis of the result of the time measurement.

It should be noted that the comparison between the calculated operation amount and the threshold T2a during the continuation of the second mode is merely exemplary and not limiting. The controller 17 may shift the operating mode of the first evacuation system 150 from the second mode to the first mode if the differential pressure ΔP1 between the seal chamber pressure P1 and the external pressure P0 input from the pressure sensor 18a or 18b is not more than a predetermined threshold, which is also included within the scope of the present invention. In this case, the above-described threshold has previously been measured by experiments or the like and recorded in a predetermined memory (not shown) herein as the maximum differential pressure that can be evacuated in the first mode without hunting or the like generated by the inert gas suddenly increasing in the main chamber 11 in the course of the treatment by the injection treatment device 10.

### Third Embodiment

A processing apparatus according to a third embodiment of the present invention will be described. In the following description, the same component as those of the first embodiment are denoted by the same reference numerals and differences between the first embodiment and the second embodiment will be mainly described. The matters that are not particularly described are the same as in the first embodiment. This embodiment differs from the first embodiment in that it includes a second evacuation system for evacuating the inert gas from the main chamber, in addition to the first evacuation system for evacuating the inert gas from the inlet seal chamber and the outlet seal chamber.

In the third embodiment, evacuation from the main chamber is also performed to further control the differential pressure between the internal pressure of the main chamber and the external pressure of the main chamber, in addition to the control of the differential pressure between the pressure in the seal chamber and the external pressure of the main chamber. By performing evacuation from the main chamber in this way, outflow of the gas to the exterior is suppressed, even if the injection quantity of the inert gas injected by the injection treatment device is large. Such an outflow would otherwise occur because the pressure in the seal chamber becomes higher than the external pressure as a result of inflow of excessive gas from the main chamber into the seal chamber. This will now be described in detail.

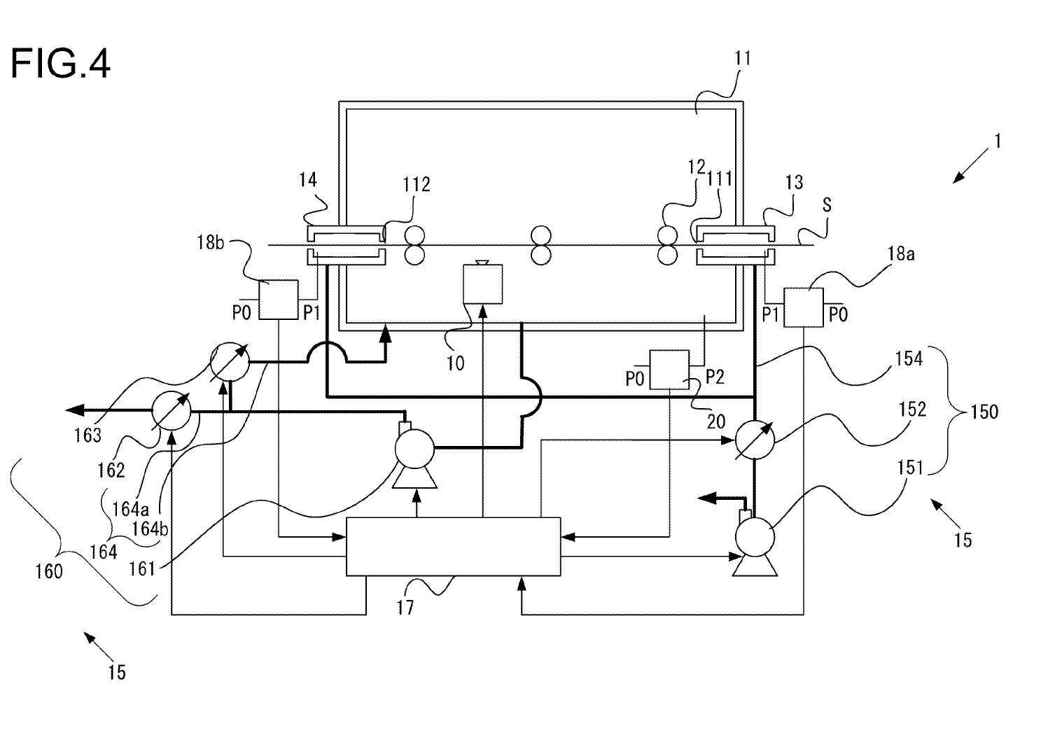

As illustrated in FIG. 4, the processing apparatus 1 according to the third embodiment further includes a main chamber pressure sensor 20 and the evacuation device 15 has the second evacuation system 160, in addition to the first evacuation system 150. The main chamber pressure sensor 20 has two pressure measurement ports, one of which is connected to the main chamber 11, while the other is open to the exterior of the main chamber 11. Thus, the main chamber pressure sensor 20 detects the differential pressure between the external pressure P0 and the pressure P2 in the main chamber 11 and then outputs signals according to the detected differential pressures (referred to as “main chamber differential pressure signals” hereinafter) to the controller 17. The second evacuation system 160 of the evacuation device 15 has a second fan 161, a second variable valve 162, a third variable valve 163, and a duct 164 and evacuates the inert gas from the main chamber 11 in response to a drive signal from the controller 17 as described later.

The second fan 161 activates to rotate in response to input of the drive signal from the controller 17 as described later, and evacuates the inert gas in the main chamber 11 to the exterior. A fan that varies a number of rotations of a rotating blade, a fan that varies an angle of the rotating blade, or a combination of both may be used as the second fan 161, in the same way as the first fan 151. The amount that can be evacuated out of the main chamber 11 (an evacuating capability) is set on the basis of the number of rotations of the rotating blade, the angle of the rotating blade, or a combination of both, in response to the drive signal from the controller 17. A second variable valve 162 and a third variable valve 163 are constituted of motor-driven electrical control valves, and the valve apertures of the electrical control valves in the second variable valve 162 and the third variable valve 163 are regulated in accordance with the valve aperture signals input from the controller 17. As a result, the evacuation quantity of the inert gas evacuated from the main chamber 11 to the exterior is set.

The duct 164 is composed of an evacuation duct 164a for evacuating the inert gas from the main chamber 11 to the exterior and a return duct 164b for returning the inert gas that has been once evacuated from the main chamber 11 again to the main chamber 11. As illustrated in FIG. 4, the second variable valve 162 described above is provided in the evacuation duct 164a, and the third variable valve 163 described above is provided in the return duct 164b. It should be noted that the duct 164 without the return duct 164b and the third variable valve 163 is also included within the scope of the present invention. In this case, the second evacuation system 160 only evacuates the inert gas from the main chamber 11 to the exterior in response to the command from the controller 17.

The controller 17 causes the first evacuate system 150 of the evacuation device 15 to operate to regulate the evacuation quantity from the inlet seal chamber 13 and the outlet seal chamber 14 and consequently control the differential pressure ΔP1, in the same manner as in the first embodiment. Furthermore, the controller 17 controls the differential pressure between the main chamber pressure P2 in the main chamber 11 and the external pressure P0 to be within a predetermined range with the second evacuation system 160. It is assumed in the description of this embodiment that the differential pressure is controlled so that the main chamber pressure P2 is lower than the external pressure P0 by approximately 5 Pa to 10 Pa, as one example. It should be noted that the pressure of the main chamber 11 is controlled to be not exclusively the above-described values, but may preferably be set in accordance with a size of the main chamber 11, the injection quantity T1 of the inert gas injected by the injection treatment device 10, and the like.

The controller 17 causes the second evacuation system 160 to operate to regulate the evacuation quantity of the inert gas from the main chamber 11. In this case, the controller 17 outputs a drive signal to the second fan 161 for instructing an activation of the second fan 161. The controller 17 outputs the valve aperture signals specifying the valve apertures of the electrical control valves constituting the second variable valve 162 and the third variable valve 163, to the second variable valve 162 and the third variable valve 163, respectively. The controller 17 shifts the operating mode of the second evacuation system 160 between a third mode and a fourth mode to control the differential pressure between the main chamber pressure P2 and the external pressure P0.

(1) Third Mode

In the third mode, the controller 17 performs a feedback control in order to cause the second evacuation system 160 to operate on the basis of the differential pressure between the main chamber pressure P2 in the main chamber 11 and the external pressure P0. In this case, on the basis of the main chamber differential pressure signal input from the main chamber pressure sensor 20, the controller 17 calculates the valve apertures of the second variable valve 162 and the third variable valve 163, i.e. the operation amounts of the electrical control valves with a second transfer function in which the differential pressure ΔP2 between the main chamber pressure P2 and the external pressure P0, which is a second reference pressure, is a controlled variable. The controller 17 then outputs the valve apertures to the second variable valve 162 and the third variable valve 163 as the valve aperture signals. The second transfer function is a function of calculating the operation amounts of the second variable valve 162 and the third variable valve 163 for the purpose of performing a feedback control on the differential pressure ΔP2, such as a PI control and a PID control. There is no particular limitation on the functional form of the second transfer function in this embodiment and a transfer function such as a P control, a PI control, or a PID control may be implemented and used as appropriate, depending on response characteristics of a controlled system or the like. The controller 17 controls the valve apertures of the second variable valve 162 and the third variable valve 163 in a complementary manner so as to keep a constant total amount of the inert gas evacuated from the main chamber 11 through the second fan 161, while changing a ratio of the inert gas returning to the main chamber 11 and the inert gas evacuating to the exterior, which results in increase/decrease in the net evacuation quantity from the main chamber 11. For example, if 20% of the total amount of the inert gas evacuated from the main chamber 11 is returned to the main chamber 11, the valve apertures of the second variable valve 162 and the third variable valve 163 are adjusted to evacuate 80% of the total amount to the exterior.

(2) Fourth Mode

In the fourth mode, the controller 17 causes the second evacuation system 160 to operate to evacuate the gas from the main chamber 11, by performing the feedforward control, instead of the feedback control. In this case, the controller 17 outputs an injection command to the injection treatment device 10, while setting the operation amount of the electrical control valve in the second variable valve 162 to a predetermined value and outputting the operation amount to the second variable valve 162 as the valve aperture signal. For example, the controller 17 outputs the valve aperture signal so that the valve aperture of the electrical control valve in the second variable valve 162 is the maximum valve aperture. Therefore, the second evacuation system 160 operates with the evacuation quantity according to the valve aperture of the second variable valve 162. It should be noted that the valve aperture of the electrical control valve in the second variable valve 162 is kept not exclusively at the maximum valve aperture, but may be kept at a preset valve aperture, such as 90% or 80% of the maximum valve aperture, or may vary over time, which is also included within the scope of the present invention. Furthermore, the operation amount of the electrical control valve described above has previously been measured by experiments or the like and recorded in a predetermined memory (not shown) herein as a value providing an evacuation amount with which the inert gas suddenly increasing in the main chamber 11 in the course of the treatment by the injection treatment device 10 can be evacuated, with the outflow of the gas to the exterior being suppressed, even if the evacuation quantity of the gas is regulated in the third mode after a time t2 described later has elapsed. It should be noted that the second evacuation system 160 is activated not exclusively simultaneously with output of the injection command to the injection treatment device 10, but may be activated at a time prior to the output of the injection command by a predetermined time or may be activated on the basis of the injection quantity from the injection treatment device 10, which is also included within the scope of the present invention.

The controller 17 shifts the operating mode of the first evacuation device 150 between the first mode and the second mode in accordance with a predetermined condition to regulate the evacuation quantity from the inlet seal chamber 13 and the outlet seal chamber 14 and controls the differential pressure ΔP1 between the seal chamber pressure P1 and the external pressure P0, in the same manner as in the first embodiment. Furthermore, the controller 17 shifts the operating mode of the second evacuation system 160 between the third mode and the fourth mode in accordance with a predetermined condition to regulate the evacuation quantity from the main chamber 11 and consequently control the differential pressure ΔP2 between the main chamber pressure P2 and the external pressure P0. Settings of the first mode to the fourth mode with the controller 17 will now be described.

The controller 17 sets the second mode or the fourth mode, if the injection quantity T1 of the inert gas to be injected by the injection treatment device 10 during the treatment exceeds the preset predetermined threshold T1b. If the injection quantity T1 exceeds the threshold T1b, the controller 17 causes the first evacuation system 150 to operate in the second mode and causes the second evacuation system 160 to operate in the fourth mode.

If the injection quantity T1 is not more than the threshold T1b, the controller 17 causes the second evacuation system 160 to operate in the third mode. In other words, the controller 17 performs the feedback control of calculating the valve aperture signal by setting the differential pressure ΔP2 between the main chamber pressure P2 and the external pressure P0 input from the main chamber pressure sensor 20 as a controlled variable, and outputting the valve aperture signal to the second variable valve 162 and the third variable valve 163. The threshold T1b is set to be larger than the threshold T1a and has previously been measured by experiments or the like and recorded in a predetermined memory (not shown) herein as a value with which the differential pressure ΔP2 can be controlled even if the second evacuation system 160 is operated in the third mode, when the inert gas is injected into the main chamber 11 in the treatment of the injection treatment device 10.

Once the controller 17 instructs the second evacuation system 160 to operate in the fourth mode, the controller 17 initiates the timer (not shown) to start a measurement of the time from the start of the operation of the second evacuation system 160 in the fourth mode. When the predetermined time t2 has elapsed since the start of the time measurement, the controller 17 shifts the operating mode of the second evacuation system 160 from the fourth mode to the third mode. The above-described predetermined time t2 has previously been measured by experiments or the like and recorded in a predetermined memory (not shown) herein as a time required until the inert gas suddenly increasing in the main chamber 11 in the course of the treatment by the injection treatment device 10 is evacuated by the operation of the second evacuation system 160 in the fourth mode so that the differential pressure ΔP2 can be controlled by the operation of the second evacuation system 160 in the third mode.

If the injection quantity T1 is not more than the threshold T1b as described above, i.e. if the second evacuation system 160 operates in the third mode, the controller 17 performs comparison between the injection quantity T1 and the threshold T1a. In accordance with the result of the comparison, the controller 17 controls the differential pressure ΔP1 between the seal chamber pressure P1 and the external pressure P0 with the first evacuation system 150 in the same manner as in the first embodiment. In other words, the controller 17 causes the first evacuation system 150 to operate in the first mode if the injection quantity T1 is not more than the threshold T1a, and causes the first evacuation system 150 to operate in the second mode if the injection quantity T1 exceeds the threshold T1a.

It should be noted that although the controller 17 changes the valve aperture of the electrical control valve in the second variable valve 162 in the third mode and fourth mode in this embodiment, the controller 17 may change the evacuating capability of the second fan 161 or may change a combination of the evacuating capability of the second fan 161 and the valve aperture of the electrical control valve in the second variable valve 162, which is also included within the scope of the present invention.

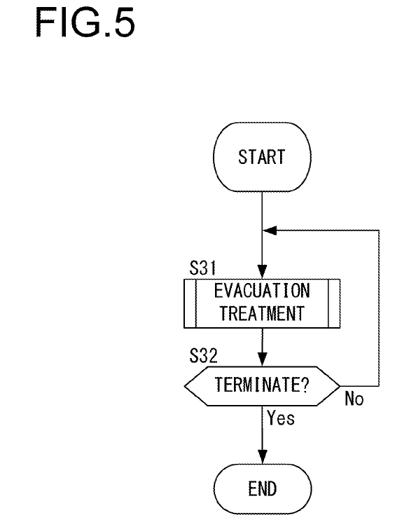

The processes of the controller 17 will be described with reference to flowcharts in FIGS. 5 to 7. Each process illustrated in the flowcharts in FIGS. 5 to 7 is performed by executing a program on the controller 17. The program has been stored in a memory (not shown) and is initiated and executed by the controller 17 with the start of the operation of the processing apparatus 1.

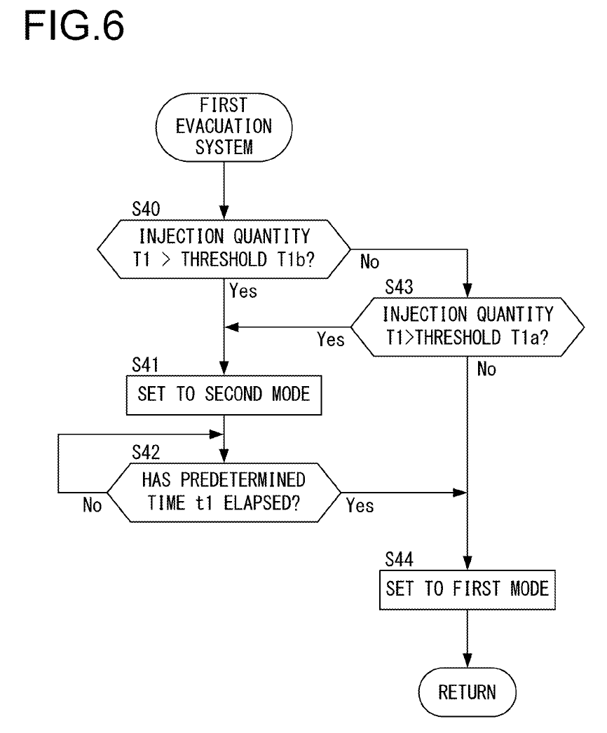

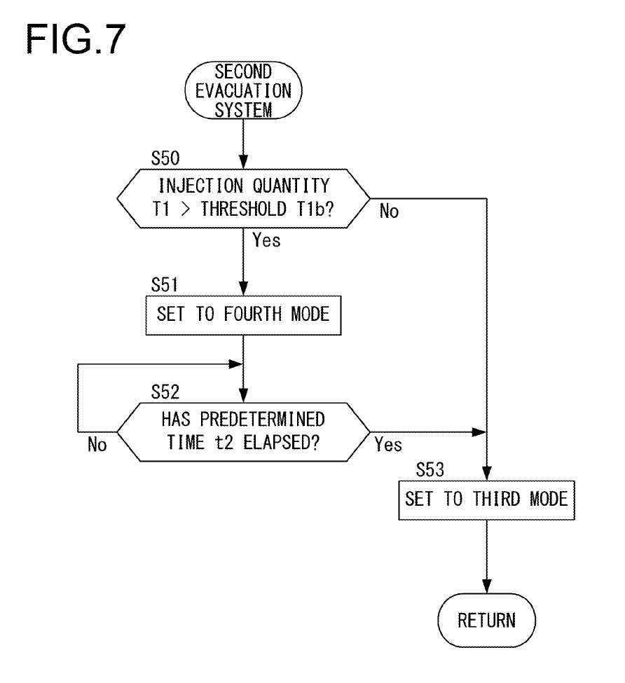

In step 31 in FIG. 5, an evacuation process is performed, and the process flow proceeds to step S32. The details of the evacuation process will be described later with reference to FIGS. 6 and 7. In step S32, it is determined if the operation of the processing apparatus 1 should be terminated. If the operation of the processing apparatus 1 should be terminated, the determination in step S32 is positive and the process ends. If the processing apparatus 1 continues its operation, the determination is step S32 is negative and the process returns to step S30.

A process that causes the first evacuation system 150 to operate in the evacuation process in step 31 will now be described with reference to FIG. 6. In step S40, it is determined if the injection quantity T1 of the inert gas to be injected by the injection treatment device 10 exceeds the threshold T1a. If the injection quantity T1 exceeds the threshold T1a, the determination is step S40 is positive and the process returns to step S41. If the injection quantity T1 is not more than the threshold T1b, the determination in step S40 is negative and the process flow proceeds to step S43 described later.

In step S41, the first evacuation system 150 is operated in the second mode and the process flow proceeds to step S42. In step S41, a timer (not shown) is initiated to start a time measurement. In step S42, it is determined if a predetermined time t1 has elapsed since the start of the time measurement with the timer in step S41. If the predetermined time t1 has elapsed, the determination in step S42 is positive and the process flow proceeds to step S44 described later. If the predetermined time t1 has not elapsed, the determination in step S42 is negative and the process in step S42 is repeated.

If the injection quantity T1 is not more than the threshold T1b, the determination in step S40 is negative and the process flow proceeds to step S43. In step S43, it is determined if the injection quantity exceeds the threshold T1a. If the injection quantity exceeds the threshold T1a, the determination in step S43 is positive and the process returns to step S41. If the injection quantity T1 is not more than the threshold T1a, the determination in step S43 is negative and the process flow proceeds to step S44. In step S44, the first evacuation system 150 is operated in the first mode and the process flow illustrated in FIG. 6 is ended.

A process that causes the second evacuation system 160 to operate in the evacuation process in step 31 in FIG. 5 will now be described with reference to FIG. 7. In step S50, it is determined if the injection quantity T1 of the inert gas injected by the injection treatment device 10 exceeds the threshold T1b. If the injection quantity T1 exceeds the threshold T1b, the determination is step S50 is positive and the process returns to step S51. If the injection quantity T1 is not more than the threshold T1b, the determination in step S50 is negative and the process flow proceeds to step S53 described later.

In step S51, the second evacuation system 160 is operated in the fourth mode and the process flow proceeds to step S52. In step S51, a timer (not shown) is initiated to start a time measurement. In step S52, it is determined if a predetermined time t2 has elapsed since the start of the time measurement with the timer in step S51. If the predetermined time t2 has elapsed, the determination in step S52 is positive and the process flow proceeds to step S53. If the predetermined time t2 has not elapsed, the determination in step S52 is negative and the process in step S52 is repeated. If the injection quantity T1 is not more than the threshold T1b, the determination in step S50 is negative and the process flow proceeds to step S53. In step S53, the second evacuation system 160 is operated in the third mode and the process flow illustrated in FIG. 7 is ended.

### Example

An example in the third embodiment will now be described. The main chamber 11 that is one of components of the processing apparatus 1 has dimensions of 1340 mm×1300 mm×590 mm and has a volume of approximately 1.2 m³. The processing apparatus 1 includes four injection treatment devices 10, two of which perform a film forming treatment on a front surface of the workpiece S and the other two perform a film forming treatment on a rear surface of the workpiece S. On/off of injection in the four injection treatment devices 10 are individually controlled. A total injection quantity T1 of the four injection treatment devices 10 is one of 0 m³/min, 0.3 m³/min, 0.6 m³/min, 0.9 m³/min, and 1.2 m³/min in four stages and the injection quantity T1 can be increased/decreased at an interval of up to 1 second. The first fan 151 operates with an airflow rate of 8.1 m³/min, a static pressure of 2.1 kPa, and a power of 0.4 kw/200 V. The second fan 161 operates with an airflow rate of 12 m³/min, a static pressure of 2 kPa, and a power of 0.4 kw/200V. Electrical control valves in the first variable valve 152, the second variable valve 162, and the third variable valve 163 perform an action between a full open position and a full close position within 1.5 second. A duct 154 is a tube having a diameter of 40 mm and a duct 164 is a tube having a diameter of 80 mm.

According to the processing apparatus 1 in the third embodiment described above, the following advantages can be achieved, in addition to the advantages (1) to (4) achieved by the first embodiment.

(1) In the third mode, the controller 17 performs the feedback control on the differential pressure ΔP2 in accordance with the operation amount calculated with the second transfer function in which the differential pressure ΔP2 between the main chamber pressure P2 and the external pressure P0 is the controlled variable. In the fourth mode, the controller 17 sets the evacuation quantity to a predetermined set value, irrespective of the differential pressure ΔP2 between the internal pressure P2 of the main chamber 11 and the external pressure P0. The controller 17 is adapted to shift the control mode of the second evacuation system 160 from the third mode to the fourth mode if the injection quantity T1 of the inert gas injected by the injection treatment device 10 into the main chamber 11 exceeds the threshold T1b. With the above-described configuration, by performing the evacuation from the main chamber 11 in addition to the evacuation from the inlet seal chamber 13 and the outlet seal chamber 14, it is possible to suppress the amount of the inert gas flowing from the main chamber 11 into the inlet seal chamber 13 and the outlet seal chamber 14. Therefore, the seal chamber pressure P1 can be quickly returned to a pressure lower than the external pressure P0 by a predetermined pressure. Consequently, even if the main chamber pressure P2 significantly varies in the course of the injection by the injection treatment device 10, outflow of the inert gas to the exterior of the main chamber 11 and inflow of outside air into the main chamber 11 can be suppressed, which results in improvement in gas tightness in the main chamber 11.

(2) The controller 17 is adapted to shift the operating mode of the second exhaust system 160 from the fourth mode to the third mode, when the predetermined time t2 has elapsed since the shift to the fourth mode. Therefore, by switching between the feedback control and the feedforward control with a simple mechanism as appropriate, the seal chamber pressure P1 can be kept lower than the external pressure P0 and thus it is possible to suppress outflow of the inert gas from the main chamber 11 to the exterior and inflow of outside air into the main chamber 11.

(3) The second evacuation system 160 includes a return duct 164b returning the inert gas from the evacuation side of the second fan 161 into the main chamber 11, and a third variable valve 163 provided in the return duct 164b. The controller 17 is adapted to control at least one of the evacuation quantity of the second fan 161 and the valve apertures of the second variable valve 162 and the third variable valve 163 to regulate the evacuation quantity of the second evacuation system 160. Therefore, outflow of the inert gas to the exterior of the main chamber 11 and inflow of outside air into the main chamber 11 can be suppressed, which results in improvement in gas tightness in the main chamber 11 with a simple configuration with a fan. It is possible to achieve the same effect with a vacuum pump such as a rotary pump, a rolling piston type pump, or the like, instead of the first fan 51.

### Fourth Embodiment

A processing apparatus according to a fourth embodiment of the present invention will be described. In the following description, the same component as those of the third embodiment are denoted by the same reference numerals and differences between the third embodiment and the fourth embodiment will be mainly described. The matters that are not particularly described are the same as in the third embodiment. In this embodiment, the processing apparatus differs from the third embodiment in terms of the following features (1) and (2).

(1) The operating mode of the first evacuation system is shifted from the second mode to the first mode on the basis of the differential pressure between the seal chamber pressure P1 and the external pressure P0.
(2) The operating mode of the second evacuation system is shifted from the fourth mode to the third mode on the basis of the differential pressure between the main chamber pressure P2 and the external pressure P0.

(1) Shifting the operating mode of the first evacuation system from the second mode to the first mode on the basis of the differential pressure between the seal chamber pressure P1 and the external pressure P0

The controller 17 performs the same process as in the second embodiment. In other words, the controller 17 performs the comparison between the operation amount calculated with the first transfer function and the threshold T2a at a predetermined period (time interval), while the evacuation device 15 continues to be controlled in the first mode. If the comparison shows that the calculated operation amount is not more than the threshold T2a, the controller 17 determines that the differential pressure ΔP1 between the seal chamber pressure P1 and the external pressure P0 decreases to a pressure that can be controlled in the first mode, as a result of decrease in the seal chamber pressure P1. The controller 17 then causes the first evacuation system 150 to operate, shifting from the second mode to the first mode.

(2) Shifting the operating mode of the second evacuation system from the fourth mode to the third mode on the basis of the differential pressure between the main chamber pressure P2 and the external pressure P0.

The controller 17 calculates the valve aperture of the third variable valve 163, i.e. the operation amount of the electrical control valve with a second transfer function in which the differential pressure ΔP2 between the main chamber pressure P2 and the external pressure P0 based on the main chamber pressure signal input from the main chamber pressure sensor 20 is the controlled variable, even after starting the operation of the second evacuation system 160 in the fourth mode. The controller 17 performs comparison between the calculated operation amount and a predetermined threshold T2b. If the comparison shows that the calculated operation amount is not more than the threshold T2b, the controller 17 determines that the differential pressure ΔP2 between the main chamber pressure P2 and the external pressure P0 decreases to a pressure that can be controlled in the third mode, as a result of decrease in the main chamber pressure P2. The controller 17 then causes the second evacuation system 160 to operate, shifting from the fourth mode to the third mode.

The controller 17 performs the calculation of the operation amount and the comparison between the operation amount and the threshold T2b in a predetermined period (time interval), while the second evacuation system 160 continues to be operated in the fourth mode. The above-described threshold T2b has previously been measured by experiments or the like and recorded in a predetermined memory (not shown) herein as an operation amount that can be evacuated in the third mode without hunting or the like generated by the inert gas suddenly increasing in the main chamber 11 in the course of the treatment by the injection treatment device 10.

The processes of the controller 17 will be described with reference to flowcharts in FIGS. 5, 8, and 9. Each process illustrated in the flowcharts in FIGS. 5, 8, and 9 is performed by executing a program on the controller 17. The program has been stored in a memory (not shown) and is initiated and executed by the controller 17 with the start of the operation of the processing apparatus 1.

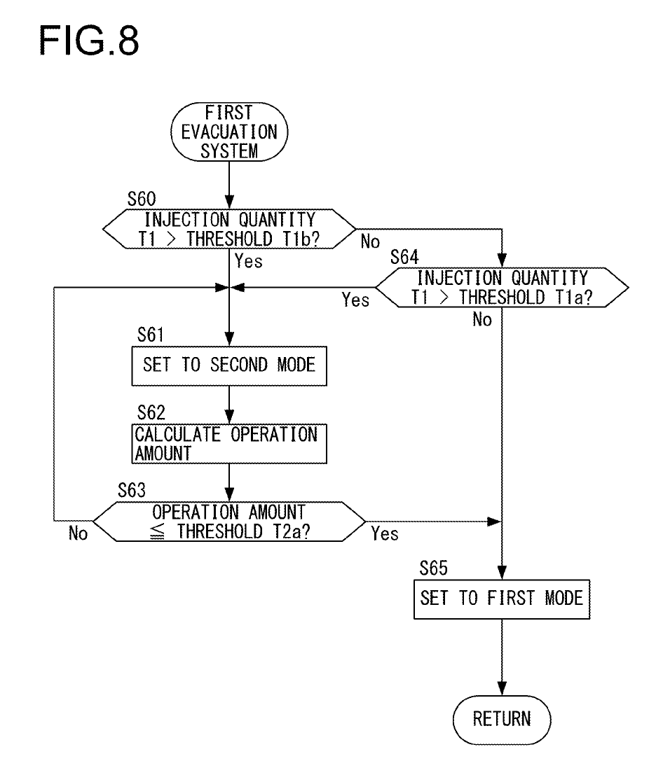

FIG. 8 illustrates a process that causes the first evacuation system 150 to operate in step S31 in FIG. 5. Each of processes in step S60 (determination of magnitude relation between the injection quantity T1 and the threshold T1b) to step S61 (set to the second mode) is the same as each of processes in step S40 (determination of magnitude relation between the injection quantity T1 and the threshold T1b) to step S42 (set to the second mode) in FIG. 6.

In step S62, the valve aperture of the first variable valve 152, i.e. the operation amount of the electrical control valve is calculated with the first transfer function in which the differential pressure ΔP1 between the seal chamber pressure P1 and the external pressure P0 based on the seal chamber pressure signal input from the pressure sensor 18a or 18b is the controlled variable, and the process flow proceeds to step S63. In step S63, it is determined if the operation amount calculated in step S62 is not more than the threshold T2a. If the operation amount is not more than the threshold T2a, the determination in step S63 is positive and the process flow proceeds to step S65. If the operation amount exceeds the threshold T2a, the determination in step S63 is negative and the process returns to step S61. Each of processes in step S64 (determination of magnitude relation between the injection quantity T1 and the threshold T1a) and step S65 (set to the first mode) is the same as each of processes in step S43 (determination of magnitude relation between the injection quantity T1 and the threshold T1a) and step S44 (set to the first mode) in FIG. 6.

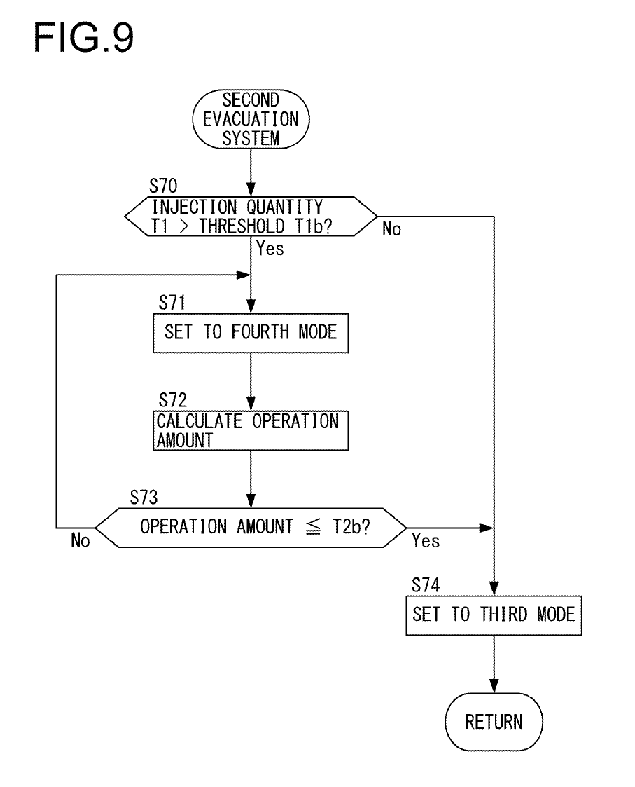

FIG. 9 illustrates a process that causes the second evacuation system 160 to operate in step S31 in FIG. 5. Each of processes in step S70 (determination of magnitude relation between the injection quantity T1 and the threshold T1a) and step S71 (set to the fourth mode) is the same as each of processes in step S50 (determination of magnitude relation between the injection quantity T1 and the threshold T1a) and step S51 (set to the second mode) in FIG. 7.

In step S72, the valve aperture of the third variable valve 163, i.e. the operation amount of the electrical control valve is calculated with the second transfer function in which the differential pressure ΔP2 between the main chamber pressure P2 and the external pressure P0 based on the main chamber pressure signal input from the main chamber pressure sensor 20 is the controlled variable, and the process flow proceeds to step S73. In step S73, it is determined if the operation amount calculated in step S72 is not more than the threshold T2a. If the operation amount is not more than the threshold T2b, the determination in step S73 is positive and the process flow proceeds to step S74. If the operation amount is exceeds than the threshold T2b, the determination in step S73 is negative and the process returns to step S71. In step S74, the second evacuation system 160 is operated in the third mode and the process flow illustrated in FIG. 9 is ended, in the same manner as step S53 in FIG. 7.

According to the processing apparatus 1 in the fourth embodiment described above, the following advantages can be achieved, in addition to the advantages (1) to (3) achieved by the first embodiment and (1) and (3) achieved by the third embodiment.

The controller 17 is adapted to compare the value of the operation amount calculated with the second transfer function and the threshold T2a during the continuation of the fourth mode and return the operating mode of the second evacuation system 160 from the fourth mode to the third mode if the value of the calculated operation amount is lower than the threshold T2a. Therefore, because the return to the third mode can be directly performed on the basis of the operation amount, gas tightness of the main chamber 11 can be kept with a higher accuracy than that in the return to the third mode on the basis of the result of the time measurement.

It should be noted that the controller 17 may shift the operating mode of the first evacuation system 150 from the second mode to the first mode if the differential pressure ΔP1 between the seal chamber pressure P1 and the external pressure P0 input from the pressure sensor 18a or 18b is not more than a predetermined threshold, which is also included within the scope of the present invention. In this case, the above-described threshold has previously been measured by experiments or the like and recorded in a predetermined memory (not shown) herein as the maximum differential pressure that can be evacuated in the first mode without hunting or the like generated by the inert gas suddenly increasing in the main chamber 11 in the course of the treatment by the injection treatment device 10.

Furthermore, the controller 17 may shift the operating mode of the second evacuation system 160 from the fourth mode to the third mode if the differential pressure ΔP2 between the main chamber pressure P2 and the external pressure P0 input from the main chamber pressure sensor 20 is not more than a predetermined threshold, which is also included within the scope of the present invention. In this case, the above-described threshold has previously been measured by experiments or the like and recorded in a predetermined memory (not shown) herein as the maximum differential pressure that can be evacuated in the third mode without hunting or the like generated by the inert gas suddenly increasing in the main chamber 11 in the course of the treatment by the injection treatment device 10.

In the third and fourth embodiments described above, the external pressure P0 is commonly used both as the first reference pressure and as the second reference pressure. Then, the evacuation quantity of the first evacuation system is regulated on the basis of the differential pressure ΔP1 between the seal chamber pressure P1 and the external pressure P0, and the evacuation quantity of the second evacuation system is regulated on the basis of the differential pressure ΔP2 between the main chamber pressure P2 and the external pressure P0, with a result that the differential pressure between the main chamber pressure P2 and the seal chamber pressure P1 is controlled to be a desired value, and therefore a backflow of the gas from the seal chamber to the main chamber 11 is suppressed. In this case, because the seal chamber pressure P1 and the main chamber pressure P2 are controlled on the basis of the common reference pressure P0, variations in the reference pressure have less effect on the differential pressure control, which results in an accurate differential pressure control.

Other embodiments of the present invention include an embodiment in which the main chamber pressure P2 is the first reference pressure, and an embodiment in which the seal chamber pressure P1 is the second reference pressure.

(1) The differential pressure ΔP1 between the seal chamber pressure P1 and the external pressure P0 is controlled with the external pressure P0 as the first reference pressure, while the differential pressure between the main chamber pressure P2 and the seal chamber pressure P1 is controlled with the seal chamber pressures P1 as the second reference pressure. In this case, the second evacuation system 160 can evacuate the gas with a higher responsivity, because the pressure in the seal chamber having a smaller capacity is the second reference pressure.

(2) The differential pressure between the seal chamber pressure P1 and the main chamber pressure P2 is controlled with the main chamber pressure P2 as the first reference pressure, while the differential pressure ΔP2 between the main chamber pressure P2 and the external pressure P0 is controlled with the external pressure P0 as the second reference pressure. In this case, even if the inert gas suddenly increases in the main chamber 11 in the course of the treatment by the injection treatment device 10, the first evacuation system 150 can evacuate the gas with a higher responsivity to change in pressure in the main chamber 11, because the differential pressure between the seal chamber pressure P1 and the main chamber pressure P2 is directly measured and controlled. Therefore, outflow of the inert gas from the seal chamber and/or inflow of the gas from the seal chamber to the main chamber can be suppressed. Furthermore, it is possible to reduce occurrence of hunting that largely vibrates the above-described differential pressure. Moreover, by setting the pressure in the main chamber 11 as the first reference pressure, the differential pressure to be controlled has a smaller value than that in the case where the differential pressure ΔP1 is to be controlled with the external pressure P0 as the first reference pressure. Therefore, the first evacuation system 150 can be driven with a lower power.

The present invention encompasses the following variations of the processing apparatus 1 described in the first to fourth embodiments.

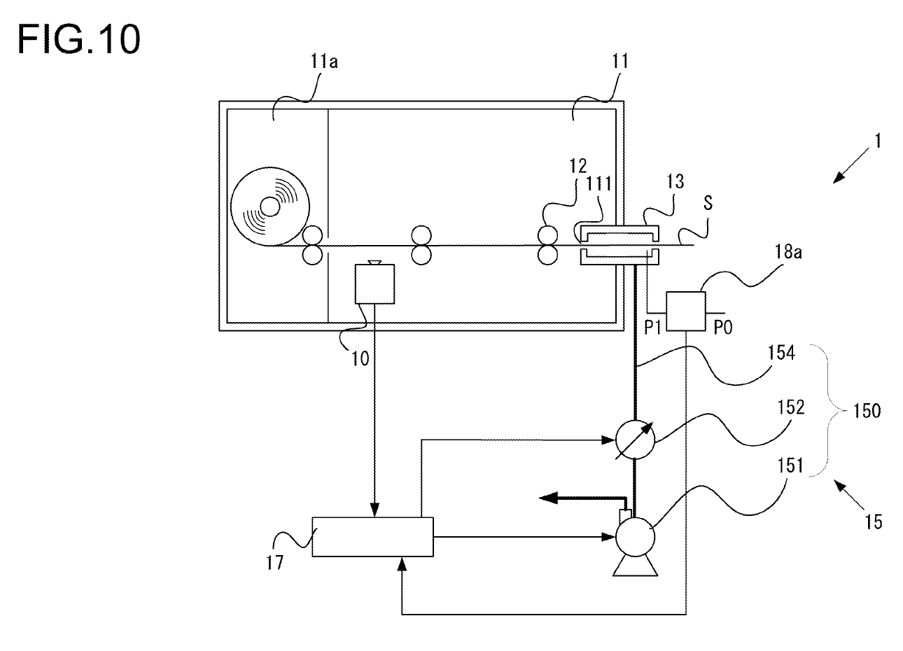

(1) The main chamber 11 may include either one of the inlet port 111 and the outlet port 112 and corresponding one of the inlet seal chamber 13 and the outlet seal chamber 14, which is also included within the scope of the present invention. FIG. 10 illustrates a case where the inlet port 111 and the inlet seal chamber 13 are provided, as one example. In this case, the controller 17 causes the first evacuation system 150 to evacuate the gas from the inlet seal chamber 13 in order to control the differential pressure ΔP1 between the seal chamber pressure P1 and the external pressure P0. In the example illustrated in FIG. 10, those parts of the workpiece S fed into the main chamber 11 in the Roll to Roll scheme that have been treated are rolled up and stored in the main chamber 11, and they may subsequently be taken out of the main chamber 11 after the whole workpiece S has been treated. In this case, it is desirable to provide another chamber 11a such as a shield chamber in the main chamber 11 and feed the treated parts into the chamber 11a so that particulates injected by the injection treatment device 10 do not further attach to the treated parts.

(2) Instead of the differential pressure sensor such as the pressure sensors 18a, 18b and the main chamber pressure sensor 20, pressure sensors that measure absolute pressures of the inlet seal chamber 13, the outlet seal chamber 14, and the main chamber 11 may be provided, which is also included within the scope of the present invention. In this case, an external pressure sensor that measures the absolute pressure of the exterior of the main chamber 11 is further provided. The controller 17 obtains the seal chamber pressure P1 and the main chamber pressure P2 by calculating a difference between the absolute pressure of the inlet seal chamber 13, the outlet seal chamber 14 and the main chamber 11, and the absolute pressure of the exterior of the main chamber 11. If the absolute pressures of the inlet seal chamber 13 and the outlet seal chamber 14 are different, the seal chamber pressure P1 may be a difference between an input from one of the pressure sensors indicating a higher pressure value and the absolute pressure of the exterior.

(3) The thresholds T1a and T1b may be set on the basis of the injection quantity (m³) within a constant time, instead of the injection quantity (m³/min).

(4) A plurality of injection treatment devices may be provided in the main chamber 11 and each injection treatment devices may operate with an individual injection quantity and an individual injection timing. In this case, the thresholds T1a and T1b may be set on the basis of the total amount of the injection quantities of the injection treatment devices.

Unless impairing characteristics of the present invention, the present invention is not limited to the above-described embodiments, but other embodiments conceivable within the technical idea of the present invention are also included within the scope of the present invention.

What is claimed is:

1. A processing apparatus, comprising:
a main chamber;
a treatment unit that injects a gas in the main chamber;
a seal chamber that communicates with both interior and exterior of the main chamber;
an evacuation unit that evacuates the gas from the interior of the main chamber and/or the seal chamber; and
a control unit that controls a first differential pressure between a pressure in the seal chamber and a first reference pressure by causing the evacuation unit to operate; wherein:
the evacuation unit has a first evacuation system that evacuates the gas from the interior of the seal chamber;
the control unit has a first mode and a second mode as operating modes of the evacuation unit for controlling the first differential pressure, in the first mode the control unit causing the first evacuation system to operate with a feedback control based on the first differential pressure and in the second mode the control unit causing the first evacuation system to operate with a control different from the feedback control based on the first differential pressure; and
the control unit shifts the operating mode from the first mode to the second mode in accordance with increase in an amount of the gas injected by the treatment unit in the main chamber.

2. The processing apparatus according to claim 1, wherein:
the control unit shifts the operating mode from the first mode to the second mode if the amount of the gas injected by the treatment unit in the main chamber exceeds a first threshold.

3. The processing apparatus according to claim 1, wherein:
in the second mode, the control unit causes the first evacuation system to evacuate the gas with a preset predetermined evacuation quantity.

4. The processing apparatus according to claim 1, wherein:
the control unit shifts the operating mode from the second mode to the first mode in accordance with decrease in the pressure in the seal chamber in the second mode.

5. The processing apparatus according to claim 1, wherein:
the control unit shifts the operating mode from the second mode to the first mode when a predetermined time has elapsed since the operation mode had been shifted to the second mode.

6. The processing apparatus according to claim 4, wherein:
the control unit shifts the operating mode from the second mode to the first mode if the first differential pressure is lower than the second threshold while the second mode continues.

7. The processing apparatus according to claim 1, wherein:
the first evacuation system comprises a first evacuation device that evacuates the gas from the interior of the seal chamber, and a first variable valve provided on an intake side or an evacuation side of the first evacuation device; and
the control unit controls the first differential pressure by changing at least one of an evacuating capability of the first evacuation device and a valve aperture of the first variable valve.

8. The processing apparatus according to claim 1, wherein:
the evacuation unit has a second evacuation system that evacuates the gas from the interior of the main chamber;
the control unit further has a third mode and a fourth mode as operating modes of the evacuation unit for controlling a second differential pressure between the pressure in the main chamber and the second reference pressure, in the third mode the control unit causing the second evacuation system to operate with a feedback control based on the second differential pressure and in the fourth mode the control unit causing the second evacuation system to operate with a control different from the feedback control based on the second differential pressure; and
the control unit shifts the operating mode from the third mode to the fourth mode, in accordance with the amount of the gas injected by the treatment unit in the main chamber.

9. The processing apparatus according to claim 8, wherein:
the control unit shifts the operating mode from the third mode to the fourth mode if the amount of the gas injected by the treatment unit in the main chamber exceeds a third threshold.

10. The processing apparatus according to claim 8, wherein:
in the fourth mode, the control unit causes the second evacuation system to evacuate the gas from the interior of the main chamber with a preset predetermined evacuation quantity.

11. The processing apparatus according to claim 8, wherein:
the control unit shifts the operating mode from the fourth mode to the third mode in accordance with decrease in pressure in the main chamber in the fourth mode.

12. The processing apparatus according to claim 8, wherein:
the control unit shifts the operating mode from the fourth mode to the third mode, when a predetermined time has elapsed since the operating mode had been shifted to the fourth mode.

13. The processing apparatus according to claim 11, wherein:
the control unit shifts the operating mode of the second evacuation system from the fourth mode to the third mode if the second differential pressure is lower than the fourth threshold while the fourth mode continues.

14. The processing apparatus according to claim 8, wherein:
the second evacuation system comprises a second evacuation device that evacuates the gas from the interior of the seal chamber, and a second variable valve provided on an intake side or an evacuation side of the second evacuation device; and
the control unit controls the second differential pressure by changing at least one of an evacuating capability of the second evacuation device and a valve aperture of the second variable valve.

15. The processing apparatus according to claim 8, wherein:
the second evacuation system has a return path that returns the gas from the evacuation side of the second evacuation device into the main chamber, and a third variable valve provided in the return path; and
the control unit controls the second differential pressure by changing at least one of an evacuating capability of the second evacuation device and valve apertures of the second variable valve and the third variable valve.

16. The processing apparatus according to claim 15, wherein:
the control unit changes the valve apertures of the second variable valve and the third variable valve in a complementary manner.

17. The processing apparatus according to claim 1, wherein:
the first reference pressure is a pressure of the interior of the main chamber or a pressure of the exterior of the seal chamber.

18. The processing apparatus according to claim 8, wherein:
the second reference pressure is a pressure of the exterior of the main chamber or a pressure of the interior of the seal chamber.

19. The processing apparatus according to claim 8, wherein:
the first threshold is lower than the third threshold.

20. An injection treatment method, comprising:
performing an injection treatment on a workpiece, by using the processing apparatus according to claim 1, in the main chamber.

21. The injection treatment method according to claim 20, wherein:
the injection treatment includes injecting a gas-solid two phase flow to the workpiece.

22. An electrical material manufacturing method, comprising:
forming an active material film on a surface of a collector, by using the processing apparatus according to claim 1.
